(19) United States
(12) Patent Application Publication
(10) Pub. No.: US 2026/0369538 A1
(43) Pub. Date: Nov. 19, 2026

(54) DATA INDEPENDENT ACQUISITION METHOD AND ION MOBILITY SPECTROMETER-TANDEM MASS SPECTROMETER

(71) Applicant: SHIMADZU CORPORATION, Kyoto-shi (JP)

(72) Inventors: Xiaoqiang ZHANG, Shanghai (CN); Lin Liu, Shanghai (CN); Wenjian SUN, Shanghai (CN)

(21) Appl. No.: 19/656,625

(22) Filed: Apr. 23, 2026

(30) Foreign Application Priority Data
May 15, 2025 (CN) 202510629291.9

(51) Int. Cl. H01J 49/00; H01J 49/42

(52) U.S. Cl. CPC H01J 49/004; H01J 49/0031; H01J 49/4215

(57) ABSTRACT

A first aspect of this application provides a data independent acquisition method applied to an ion mobility spectrometer-tandem mass spectrometer and including a pre-acquisition step and a tandem analysis step, and provides an ion mobility spectrometer-tandem mass spectrometer including an ion mobility analyzer, a mass filter, an ion dissociation device, and a mass spectrometer arranged in sequence. The data independent acquisition method according to this application can improve a data quality, a scan speed, and coverage of a region of interest, improve a sensitivity and coverage of omics analysis, and achieve high efficiency in ion utilization while maintaining a favorable ion duty cycle.

### BACKGROUND

This application relates to the field of mass spectrometry, and specifically relates to a data independent acquisition method and an ion mobility spectrometer-tandem mass spectrometer.

Currently, a tandem mass spectrometry has become an important analytical instrument for omics analysis (including metabolomics, proteomics, and the like). For complex samples in the omics analysis, a data acquisition method with high throughput, high sensitivity, and high coverage is needed.

A method in the related art of applying the tandem mass spectrometry to the omics analysis is data dependent acquisition (DDA) proposed by Ducret et al. in 1998, in which parent ions (or "precursor" ions) are scanned, and then the parent ions with a higher abundance are selected and sequentially enter an ion dissociation device for dissociation and obtain a daughter ion (or "product" ion) spectrogram. This method can achieve higher analyte coverage, and thus is still a widely adopted acquisition method.

In recent years, data independent acquisition (DIA) has developed rapidly. The DIA method does not perform collision-induced dissociation and analysis on specific parent ions, but performs the collision-induced dissociation and analysis on ion clusters within a specific mass-to-charge ratio window or all mass number, and then analyzes the obtained complex spectral data. Compared to the DDA method, the DIA method can accurately identify ions with a lower abundance, and has a higher sensitivity, a wider dynamic range, a higher analysis throughput, and better quantitative capabilities.

In order to further improve the sensitivity of the tandem mass spectrometry and increase dimensions of orthogonal separation, more and more manufacturers are coupling an ion mobility spectrometer (IMS: ion mobility spectrometry) to a tandem mass spectrometer, so that different ions are separated according to different ion mobility properties thereof, thereby improving an ion identification capability. For example, US Patent No. US9891194 combines the trapped ion mobility spectrometry (TIMS) technique and the DIA/DDA technique to form a parallel accumulation-serial fragmentation (PASEF) scheme.

The combination of the parallel accumulation-serial fragmentation and the DIA method has also developed rapidly in recent years. An article of "Nature Methods, 17, December 2020, 1229 to 1236" has proposed a DIA-PASEF method in which the PASEF is applied to the DIA acquisition method, a specially designed ion mobility-quadrupole mass spectrometry scan process is utilized to increase an acquisition efficiency of the DIA methods in the related art by several times, which allows for deeper analysis of protein samples with improved reproducibility. Another similar method that has been developed includes Synchro-PASEF, midiaPASEF, Sliced-PASEF, and the like, and these methods are all described in the review article "Eleven shades of PASEF, Expert Rev Proteomics. 2024 Sep-Oct; 21(9-10): 367 to 376".

However, in the data independent acquisition method in the related art combined with the PASEF technique, there is a problem in balancing data quality and duty cycle.

### SUMMARY

In view of the above problem, this application provides an ion mobility spectrometer-tandem mass spectrometer and a data independent acquisition method which is capable of balancing data quality and duty cycle and further improving sensitivity and coverage of omics analysis.

In one or more embodiments, this application provides a data independent acquisition method applied to an ion mobility spectrometer-tandem mass spectrometer, the ion mobility spectrometer-tandem mass spectrometer including an ion mobility analyzer, a mass filter, an ion dissociation device, and a mass spectrometer arranged in sequence, the data independent acquisition method including:
a pre-acquisition step of transporting, to the mass spectrometer, a parent ion that is analyzed by the ion mobility analyzer and is not dissociated by the ion dissociation device to obtain a parent ion pre-acquisition data set in which ion mobility spectral data of the parent ion is stored in association with mass spectral data of the parent ion; and
a tandem analysis step of controlling, using an ion selection timing determined based on the parent ion pre-acquisition data set, operations of the ion mobility analyzer and the mass filter to select the parent ion that satisfies the ion selection timing to enter the ion dissociation device, and transporting, to the mass spectrometer, a daughter ion obtained by dissociating the parent ion to obtain a data-independent acquisition data set, in which
an operation cycle of the tandem analysis step includes a plurality of ion mobility spectrometry scan cycles, and the ion mobility analyzer performs a scan continuously or stepwise in each of the plurality of ion mobility spectrometry scan cycles, and
the ion mobility spectrometry scan cycle includes a plurality of time periods that are sequentially continuous with each other, and a mass selection window of the mass filter changes continuously or stepwise in each of the time periods and step changes at a timing of switching between the time periods.

Optionally, the pre-acquisition step includes: determining an ion mobility-mass-to-charge ratio two-dimensional heat map of the parent ion based on the parent ion pre-acquisition data set; and representing the time period of the ion mobility spectrometry scan cycle as a non-rectangular parallelogram region in the ion mobility-mass-to-charge ratio two-dimensional heat map according to the mass selection window and an ion mobility selection window.

Optionally, the data independent acquisition method further includes: a trend line determination step of determining one or more trend lines based on a contour of a region with a relatively high heat value in the ion mobility-mass-to-charge ratio two-dimensional heat map.

Optionally, in each of the time periods, a slope of the parallelogram region is different from a slope of the one or more trend lines.

Optionally, in the ion mobility-mass-to-charge ratio two-dimensional heat map, 1/K0 is set as a vertical axis, a mass-to-charge ratio m/z is set as a horizontal axis, K0 represents a reduced ion mobility, and the slope of the parallelogram region is greater than the slope of the one or more trend lines.

Optionally, in the ion mobility spectrometry scan cycle, an ion mobility selected by the ion mobility analyzer increases or decreases in sequence over time.

Optionally, in the ion mobility spectrometry scan cycles, widths of ion mobility ranges scanned by the ion mobility analyzer are equal.

Optionally, in n time periods of one of the ion mobility spectrometry scan cycles, window widths of respective ion mobility selection windows scanned by the ion mobility analyzer are equal.

Optionally, a width of the mass selection window of the mass filter remains unchanged.

Optionally, the ion mobility analyzer includes an ion inlet, an ion outlet, and an ion channel which includes a first channel and a second channel arranged in parallel, and in an ion path from the ion inlet to the ion outlet, a moving direction of the parent ion in the first channel is opposite to a moving direction of the parent ion in the second channel.

Optionally, the parent ion is stored, selected, or excluded in the ion channel according to a comparison of magnitudes of a gas flow force and an electric field force applied to the parent ion along a length direction of the ion channel.

Optionally, the tandem analysis step includes:
storing the parent ion outside the ion mobility selection window in the first channel, or storing the parent ion outside the ion mobility selection window at an end of the second channel away from the ion outlet; and
releasing the parent ion to a lower level through the second channel and the ion outlet in an order of ion mobilities.

Optionally, the excluded parent ion leaves the ion mobility analyzer through an opening at an end of the ion channel different from the ion outlet.

Optionally, in n time periods of one of the ion mobility spectrometry scan cycles, step lengths of step changes of the mass selection window between different time periods are equal.

In one or more embodiments, this application provides an ion mobility spectrometer-tandem mass spectrometer to which the data independent acquisition method according to this application is applied.

Optionally, the mass filter is a quadrupole mass filter, the ion mobility analyzer is a U-shaped ion mobility analyzer or a trapped ion mobility analyzer, and the mass spectrometer is a time-of-flight mass spectrometer.

The one or more embodiments not only achieve data quality similar to that of DDA and better coverage of a region of interest, but also enable a higher scan speed. At the same time, assignment of the parent ion can be inferred based on an overlapping relationship between mass selection windows, and a computational efficiency and accuracy of deconvolution can be improved, thereby improving data quality.

### BRIEF DESCRIPTION OF THE SEVERAL VIEWS OF THE DRAWINGS

FIG. 1 is a schematic structural diagram of an ion mobility spectrometer-tandem mass spectrometer according to one or more embodiments of this application.

FIG. 2 is a schematic structural diagram of a U-shaped ion mobility analyzer according to one or more embodiments of this application.

FIG. 3 is a flowchart of a data independent acquisition method according to one or more embodiments of this application.

FIG. 4 is an ion mobility-mass-to-charge ratio two-dimensional heat map drawn by a heat map drawing step according to one or more embodiments of this application.

FIG. 5 is a diagram of a trend line determined by the ion mobility-mass-to-charge ratio two-dimensional heat map according to one or more embodiments of this application.

FIG. 6 is a diagram of ion mobility-mass-to-charge ratio windows arranged in sequence along the trend line according to one or more embodiments of this application.

FIG. 7 is a schematic diagram of a method for scanning the ion mobility-mass-to-charge ratio windows according to one or more embodiments of this application.

FIG. 8 is a diagram of the ion mobility-mass-to-charge ratio windows arranged in sequence along the trend line according to one or more embodiments of this application.

FIG. 9 is a schematic diagram of a method for scanning the ion mobility-mass-to-charge ratio windows according to one or more embodiments of this application.

### REFERENCE NUMERALS

Reference numerals: ion mobility spectrometer-tandem mass spectrometer 100, ion source 101, U-shaped ion mobility analyzer 102, quadrupole mass filter 103, ion dissociation device 104, mass spectrometer 105, ion optical device 106, ion inlet 201, inter-channel ion transfer port 202, ion outlet 203, electrode array 204, trend line 301, rectangular step 302, continuous region 303, ion mobility-mass-to-charge ratio window 1 to 11, 1' to 11', 1'' to 11'', first channel CH1, second channel CH2.

### DETAILED DESCRIPTION OF THE DISCLOSURE

The one or more embodiments of this application will be clearly and completely described below with reference to the accompanying drawings in some embodiments of this application, and obviously, the described embodiments are merely a part of the one or more embodiments of this application, and are not all embodiments. Based on the one or more embodiments in this application, all other embodiments obtained by those skilled in the art without creative operation fall within the protection scope of this application.

A term "ion mobility spectrometer-tandem mass spectrometer" does not limit a combination use of only ion mobility spectrometry and tandem mass spectrometry, but can also include another combination with devices, such as a chromatograph, to form a chromatograph-ion mobility spectrometer-tandem mass spectrometer.

A term "connected in sequence" does not limit that another component cannot be added between components, and the connection between the components can be indirect. For example, "ion source, U-shaped ion mobility analyzer, and mass spectrometer that are connected in sequence" means that a UMA is located at a downstream side of the ion source, and the mass spectrometer is located at a downstream side of the UMA. However, another component can be added between the UMA and the ion source, and similarly, another component can also be added between the UMA and the mass spectrometer.

A term "trap-release" refers to an operation mode of an ion mobility analyzer, and is applied to various ion mobility analyzers including UMA, TIMS, and the like. Specifically, in the "trap-release" mode, ions are enriched in a partial region of the ion mobility analyzer to form an ion packet, followed by being released to a lower level. Typically, in the "trap-release" mode, the ions are released in pulses in units of the ion packet, and are temporarily retained and stored (that is, trapped) in the partial region in a transmission path, rather than being continuously released to the lower level.

A term "step change" is a term relative to "continuous or stepwise change", and a magnitude of the "step change" should be multiple times a unit of a magnitude of the "continuous or stepwise change", and for example, 2 times or higher, 5 times or higher, or 10 times or higher the unit of magnitude of the change.

A two-dimensional heat map, a window, or a data set of a term "ion mobility-mass-to-charge ratio" is, in most cases, actually a two-dimensional heat map, a window, or a data set of "ion mobility reciprocal-mass-to-charge ratio" (1/K-m/z) or "reduced ion mobility reciprocal-mass-to-charge ratio" (1/K0-m/z), and this application describes all of these as the "ion mobility-mass-to-charge ratio" for the sake of simplicity.

Referring to FIG. 1, an ion mobility spectrometer-tandem mass spectrometer 100 according to the one or more embodiments includes an ion source 101, a U-shaped ion mobility analyzer 102, a quadrupole mass filter 103 (that is, mass filter in some embodiments), an ion dissociation device 104, and a mass spectrometer 105 that are connected in sequence. It should be noted that the above structure is merely an example, and in one or more other embodiments, a liquid chromatography analyzer may be added at an upstream side of the ion source 101.

The ion source 101 includes one ion source 101 selected from the group consisting of: (i) an electrospray ionization ("ESI") ion source; (ii) an atmospheric pressure photoionization ("APPI") ion source; (iii) an atmospheric pressure chemical ionization ("APCI") ion source; (iv) a matrix-assisted laser desorption ionization ("MALDI") ion source; (v) a laser desorption ionization ("LDI") ion source; (vi) an atmospheric pressure ionization ("API") ion source; (vii) an on-silicon desorption ionization ("DIOS") ion source; (viii) an electron impact ("EI") ion source; (ix) a chemical ionization ("CI") ion source; (x) a field ionization ("FI") ion source; (xi) a field desorption ("FD") ion source; (xii) an inductively coupled plasma ("ICP") ion source; (xiii) a fast atom bombardment ("FAB") ion source; (xiv) a liquid secondary ion mass spectrometry ("LSIMS") ion source; (xv) an electrospray desorption ionization ("DESI") ion source; (xvi) a nickel -63 radioactive ion source; (xvii) an atmospheric pressure matrix-assisted laser desorption ionization ion source; (xviii) a thermal spray ion source; (xix) an atmospheric sampling glow discharge ionization ("ASGDI") ion source; (xx) a glow discharge ( "GD") ion source; (xxi) an impactor ion source; (xxii) a real-time direct analysis ("DART") ion source; (xxiii) a laser spray ionization ("LSI") ion source; (xxiv) an acoustic spray ionization ("SSI") ion source; (xxv) a matrix-assisted inlet ionization ("MAII") ion source; (xxvi) a solvent-assisted inlet ionization ("SAII") ion source; (xxvii) a Penning ionization ion source; (xxviii) a laser ablation electrospray ionization ("LAESI") ion source; and (xxix) He plasma (HePl) ion source. Preferably, a room pressure or real-time ion source such as the electrospray ionization ("ESI") ion source, the matrix-assisted laser desorption ionization ion source ("MALDI"), the real-time direct analysis ion source ("DART"), or the laser ablation electrospray ionization ("LAESI") ion source is employed.

In some embodiments, the ion mobility analyzer is implemented by the U-shaped ion mobility analyzer 102. In one or more embodiments of this application, the ion mobility analyzer can also be an analyzer based on drift cell ion mobility spectrometry (DT-IMS), travelling wave ion mobility spectrometry (TW-IMS), trapped ion mobility spectrometry (TIMS) technology, or a differential mobility analyzer (DMA).

The ion mobility analyzer includes a first channel CH1 and a second channel CH2. The first channel CH1 and the second channel CH2 can each be implemented by the ion mobility analyzer, and for example, the first channel CH1 is implemented by a trapped ion mobility analyzer, and the second channel CH2 is implemented by another trapped ion mobility analyzer.

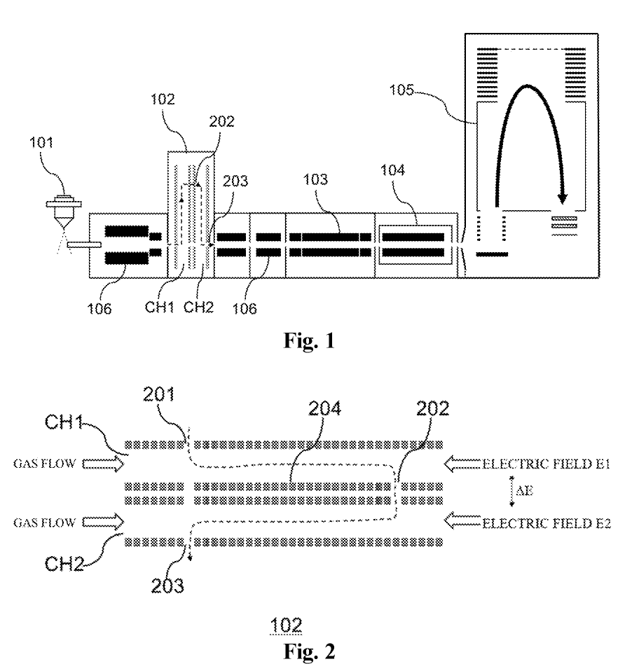

Referring to FIGS. 1 and 2, in some embodiments, the U-shaped ion mobility analyzer 102 includes the first channel CH1 and the second channel CH2. Each of the first channel CH1 and the second channel CH2 includes two sets of electrode arrays 204 arranged opposite to each other and extending perpendicular to an axial direction (referring to FIG. 1, the two sets of electrode arrays 204 on a left side, that is, a first electrode array and a second electrode array, define the first channel CH1, and the two sets of electrode arrays 204 on a right side define the second channel CH2).

The U-shaped ion mobility analyzer 102 has an ion inlet 201, an ion outlet 203, and an inter-channel ion transfer port 202. The ion inlet 201 is provided at the electrode array 204 near an upstream side of the first channel CH1, the ion outlet 203 is provided at the electrode array 204 near a downstream side of the second channel CH2, and the inter-channel ion transfer port 202 is provided at the adjacent electrode arrays 204 of the first channel CH1 and the second channel CH2. The inter-channel ion transfer port 202 allows the first channel CH1 to communicate with the second channel CH2.

The U-shaped ion mobility analyzer 102 includes a gas flow supply unit that supplies a gas flow to the first channel CH1 and the second channel CH2, a flowing direction of the gas flow is a vertical direction in FIG. 1 (horizontal direction in FIG. 2), and a balance between a gas flow propulsion and an electric field confinement in the U-shaped ion mobility analyzer 102 is along the vertical direction in FIG. 1. Therefore, when the ions do not satisfy a condition necessary for achieving the balance between the gas flow propulsion and the electric field confinement, the ions escape from openings at both ends and annihilate, rather than being further transported to the downstream side. Between the first channel CH1 and the second channel CH2, the ions may be transmitted or transferred from the first channel CH1 to the second channel CH2 through the inter-channel ion transfer port 202 using a "dipole direct current" electric field or a deflection direct current electric field.

Principles for implementing basic functions such as storing, accumulating, moving, and separating ions in the first channel CH1 and the second channel CH2 of the U-shaped ion mobility analyzer 102 can be referred to in prior patent applications CN109003877A and CN109003876A, which will not be elaborated upon here.

In some embodiments, the U-shaped ion mobility analyzer 102 may operate in a filtering mode in which the ions passing through the U-shaped ion mobility analyzer 102 substantially move continuously along an ion moving path from the ion inlet 201 to the ion outlet 203, without ion enrichment or storage in a specific region. A scheme of setting the U-shaped ion mobility analyzer 102 to the filtering mode can be referred to in CN113495112A, which will not be elaborated upon here.

In some other embodiments, the U-shaped ion mobility analyzer 102 may operate in a trap-release mode in which the first channel CH1 is used to trap the ions, and for example, a direct current electric field having a gradient change can be provided along a length direction of the first channel CH1, thereby trapping ions with different ion mobilities at different positions along the length direction of the first channel CH1. When the ions are required to be released, the direct current electric field of the first channel CH1 can be changed to transport all ions into the second channel CH2 through the inter-channel ion transfer port 202, and then a direct current electric field with an amplitude gradually changed is used to release the ions to the lower level through the ion outlet 203 in sequence.

In one or more embodiments, the ions filtered in the U-shaped ion mobility analyzer 102 may or may not be stored. A method for storing the filtered ions can be referred to in contents disclosed in CN115223844A. During another time period of one operation cycle, the filtered ions may also be returned to the first channel CH1 or the second channel CH2 to improve a duty cycle of the U-shaped ion mobility analyzer 102.

The ion dissociation device 104 is a collision induced dissociation device, an electron dissociation device, an infrared photon dissociation device, an ultraviolet photon dissociation device, or a free radical dissociation device. Preferably, the ion dissociation device 104 is a collision induced dissociation device.

The mass spectrometer 105 may be implemented by one or more of a quadrupole mass spectrometer, a time-of-flight mass spectrometer, a Fourier transform mass spectrometer, an ion trap mass spectrometer, and a magnetic mass spectrometer. Optionally, the mass spectrometer 105 is a quadrupole mass spectrometer or a time-of-flight mass spectrometer, and forms a tandem mass spectrometry in a type of Q-TOF, triple quadrupole, or the like with the quadrupole mass filter 103.

In some embodiments, in the ion mobility spectrometer-tandem mass spectrometer 100, ion optical devices 106 for performing functions such as ion focusing, guiding, or storage are provided between the ion source 101 and the U-shaped ion mobility analyzer 102 and between the U-shaped ion mobility analyzer 102 and the quadrupole mass filter 103. It should be noted that the multi-stage vacuum structure shown in FIG. 1 and the corresponding configuration of the ion optical devices 106 are merely examples. In other embodiments of this application, the multi-stage vacuum structure and the configuration of the ion optical devices 106 can be adjusted according to actual needs, and are not limited in this application.

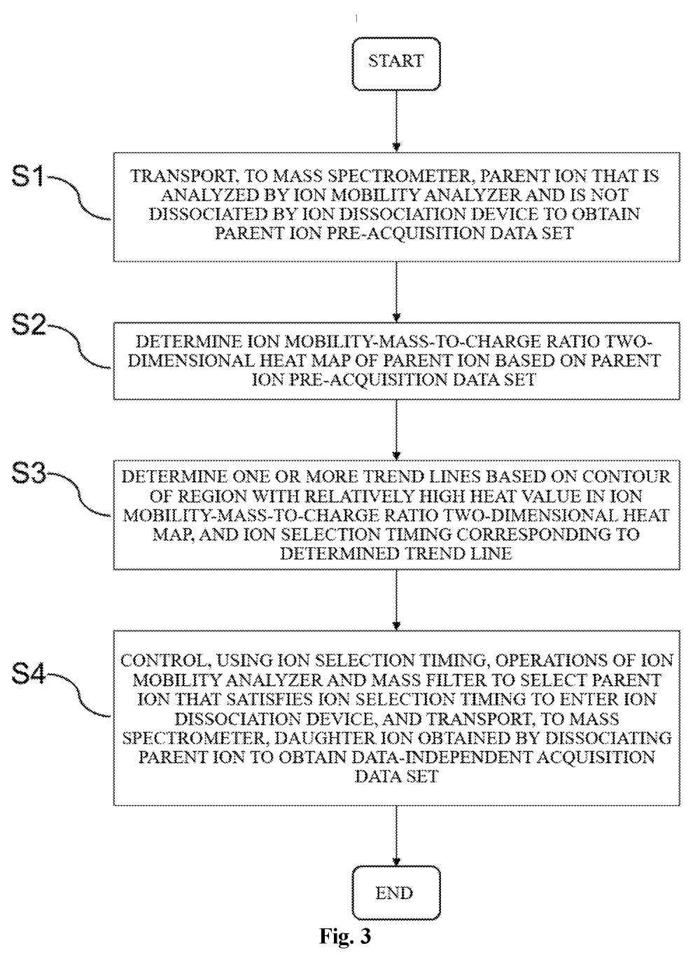

Some embodiments of this application provide a data independent acquisition method applied to the ion mobility spectrometer-tandem mass spectrometer 100 according to some embodiments of this application. Referring to FIG. 3, the data independent acquisition method includes the following steps.

Pre-acquisition step S1: transporting, to the mass spectrometer, a parent ion that is analyzed by the ion mobility analyzer and is not dissociated by the ion dissociation device to obtain a parent ion pre-acquisition data set.

Heat map drawing step S2: determining an ion mobility-mass-to-charge ratio (actually, is a reduced ion mobility reciprocal-mass-to-charge ratio, hereinafter the same) two-dimensional heat map of the parent ion based on the parent ion pre-acquisition data set.

Trend line determination step S3: determining one or more trend lines 301 and an ion selection timing corresponding to the one or more trend lines 301 based on a contour of a region with a relatively high heat value in the ion mobility-mass-to-charge ratio two-dimensional heat map and a region occupied by ions of specific valence (for example, in proteomics, high-valent peptide ions are usually selected instead of ions of +1 valence).

Tandem analysis step S4: controlling, using the ion selection timing, operations of the ion mobility analyzer and the mass filter to select the parent ion that satisfies the ion selection timing to enter the ion dissociation device, and transporting, to the mass spectrometer, a daughter ion obtained by dissociating the parent ion to obtain a data-independent acquisition data set.

Hereinafter, operation principles of the respective components in the above steps will be described in sequence with reference to the accompanying drawings.

In the pre-acquisition step S1, the U-shaped ion mobility analyzer 102 operates in the filtering mode or the trap-release mode, and sequentially transporting the parent ions generated by the ion source 101 to the lower level according to an order (descending order or ascending order) of ion mobilities. The quadrupole mass filter 103 and the ion dissociation device 104 are in a direct-pass mode which refers to that all parent ions pass directly through the quadrupole mass filter 103 and the ion dissociation device 104 without selection or dissociation. The mass spectrometer 105 performs analysis to obtain mass spectral data of the parent ions, and then, the mass spectral data and the ion mobility spectral data are associated and saved based on a temporal correspondence to obtain the parent ion pre-acquisition data set.

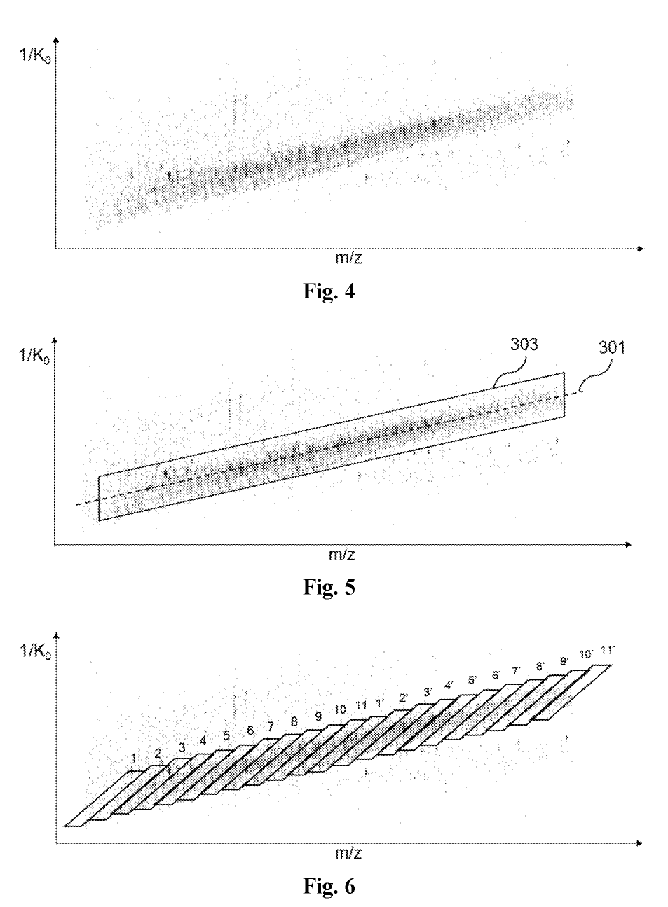

In the heat map drawing step S2, an ion mobility-mass-to-charge ratio two-dimensional heat map is drawn with 1/K0 as a vertical axis, mass-to-charge ratio m/z as a horizontal axis, and heat value as mass spectral peak intensity data. K0 represents a reduced ion mobility. FIG. 4 is the ion mobility-mass-to-charge ratio two-dimensional heat map drawn in the heat map drawing step S2 in some embodiments. It should be noted that the method for drawing the heat map in FIG. 4 is merely an example, and in order to more clearly show that ions with a high mass-to-charge ratio generally have larger collision cross-sectional areas (CCS) and smaller ion mobilities, 1/K0 is selected as the vertical axis and the mass-to-charge ratio m/z is selected as the horizontal axis. In other embodiments of this application, other parameters reflecting the collision cross-section areas (CCS) or the ion mobilities may be selected as the vertical axis, or other parameters reflecting the mass-to-charge ratio may be selected as the horizontal axis, or parameters of the horizontal axis and the vertical axis may be exchanged as needed, the one or more embodiments of this application do not limit this.

In the trend line determination step S3, first, a continuous region 303 with a relatively high heat value and ions of specific valence is identified in the ion mobility-mass-to-charge ratio two-dimensional heat map, and then, one or more trend lines 301 and an ion selection timing corresponding to each of one or more trend line 301 are determined based on an approximate shape of a contour of the continuous region 303.

FIGS. 4-6 show the method for determining the trend line 301 and the ion selection timing in the trend line determination step S3 of the one or more embodiments. Referring to FIGS. 4 and 5, in some embodiments, there is only one continuous region 303 with a relatively high heat value, and this region contains ions of +2 valence and higher valence, but does not contain ions of +1 valence, and thus, the ion mobility-mass-to-charge ratio two-dimensional heat map in some embodiments may have only one trend line 301. In other embodiments of this application, if this region is scattered, that is, there are a plurality of continuous regions 303 with a relatively high heat value, a plurality of trend lines 301 and ion selection timings corresponding to the respective trend lines 301 can be determined, and a method for determining an ion selection timing can also refer to the method for determining an ion selection timing according to the one or more embodiments, which is merely described as an example and is not elaborated upon here.

After the trend line 301 is determined, the ion selection timing corresponding to this trend line 301 needs to be determined. This ion selection timing is used to control timing coordination of operation modes of the ion mobility analyzer and the mass filter in the subsequent tandem analysis step S4. Specifically, in the subsequent tandem analysis step S4, parent ions satisfying different ion mobility and mass-to-charge ratio conditions are selected at different time periods, are transported to the ion dissociation device 104 for dissociation, and then daughter ions obtained by dissociation are transported to the mass spectrometer 105 for mass analysis.

Furthermore, both the U-shaped ion mobility analyzer 102 and the quadrupole mass filter 103 may be set in the filtering mode. In the filtering mode, the U-shaped ion mobility analyzer 102 can select ions within a certain ion mobility window and continuously transport the selected ions to the lower level, and ions that are outside the ion mobility window and not selected can be excluded or stored in a specific region of the U-shaped ion mobility analyzer 102.

Referring to FIG. 6, once the continuous region 303 with a relatively high heat value and the trend line 301 are determined, a slope k1 of the trend line 301 is also determined. In some embodiments, a plurality of ion mobility-mass-to-charge ratio (actually, reduced ion mobility reciprocal-mass-to-charge ratio, hereinafter the same) windows with a slope of k2 are generated and arranged in sequence along the trend line 301, and each of the ion mobility-mass-to-charge ratio windows corresponds to a parallelogram region which is not rectangular. Upper and lower sides of this parallelogram region are parallel to an X-axis, and left and right sides are inclined with respect to the X-axis and a Y-axis. In some embodiments, a slope of the ion mobility-mass-to-charge ratio window is a slope of the left and right sides of the parallelogram region.

The plurality of generated ion mobility-mass-to-charge ratio windows satisfy the following conditions. a. The plurality of ion mobility-mass-to-charge ratio windows, as a whole, are required to cover a region of interest (ROI) of the analysis, and the region of interest at least includes the previously determined continuous region 303 with a relatively high heat value. b. The plurality of ion mobility-mass-to-charge ratio windows can be divided into m groups, and in each group, a maximum ion mobility of the ion mobility-mass-to-charge ratio window is a minimum ion mobility of another ion mobility-mass-to-charge ratio window. In the subsequent tandem analysis step S4, by scanning different ion mobility-mass-to-charge ratio windows with front and rear ends continuously connected in one group, a continuous unidirectional scan on the ion mobility can be maintained, and the quadrupole mass filter 103 can be used to switch and perform a step change between discontinuous mass selection windows to switch the ion mobility-mass-to-charge ratio window, facilitating an instrument configuration and improving a scan speed. c. Mass-to-charge ratio window widths of the respective ion mobility-mass-to-charge ratio windows are constant.

Specifically, referring to FIG. 6, in some embodiments, a total of 22 ion mobility-mass-to-charge ratio windows that have the same shape and a slope of k2 are arranged in sequence along the trend line 301. The ion mobility-mass-to-charge ratio windows do not overlap each other. Change values Δ(1/K0) of ion mobility (actually reduced ion mobility reciprocal, the same below) selection windows between adjacent ion mobility-mass-to-charge ratio windows are the same, and change values Δm/z of the mass selection windows between adjacent ion mobility-mass-to-charge ratio windows are also the same.

In some embodiments, 22 ion mobility-mass-to-charge ratio windows are grouped into pairs, that is, 1 and 1' forming one group, 2 and 2' forming another group, and so forth. In the subsequent tandem analysis step S4, the scan on the ion mobility-mass-to-charge ratio windows with corresponding reference numerals is executed within the same scan cycle of the U-shaped ion mobility analyzer 102, and the U-shaped ion mobility analyzer 102 sequentially performs the scan on different ion mobility-mass-to-charge ratio windows.

Specifically, if the ion mobility is scanned in a descending order (that is, 1/K0 is scanned in an ascending order), the scan can be performed sequentially in an order of 1, 1', 2, 2', 3, 3', 4, 4', …, and the like. Here, an upper end of an ion mobility-mass-to-charge ratio window 1 is aligned with a lower end of an ion mobility-mass-to-charge ratio window 1', that is, a maximum value of 1/K0 corresponding to the ion mobility selection window of the ion mobility-mass-to-charge ratio window 1 is equal to a minimum value of 1/K0 corresponding to the ion mobility selection window of the ion mobility-mass-to-charge ratio window 1'. Therefore, when 1/K0 is scanned in the ascending order to an upper end of the ion mobility-mass-to-charge ratio window 1', the unidirectional continuous scan on the ion mobility by the U-shaped ion mobility analyzer 102 can be maintained, and by switching a mass selection range where the quadrupole mass filter 103 step changes to the lower end of the ion mobility-mass-to-charge ratio window 1', the ion mobility-mass-to-charge ratio window 1 can be switched to the ion mobility-mass-to-charge ratio window 1'. Similarly, the above correspondence exists between the ion mobility-mass-to-charge ratio windows in the same group, allowing the U-shaped ion mobility analyzer 102 to scan the ion mobility unidirectionally, and complete a tandem analysis on the region of interest in the ion mobility-mass-to-charge ratio two-dimensional heat map by 11 cycles of the scan. If the ion mobility is scanned in the ascending order (that is, 1/K0 is scanned in the descending order), the scan can be performed sequentially in an order of 11', 11, 10', 10, 9', 9, 8', 8, …, and the like. In other embodiments, the order of different cycles can also be adjusted, for example, the scan can be performed in the order of 9', 9, 5', 5, 7', 7, … as long as the region of interest is covered after the scan is completed.

After the ion selection timing is determined, the tandem analysis step S4 is performed.

In the tandem analysis step S4, the U-shaped ion mobility analyzer 102, the quadrupole mass filter 103, the ion dissociation device 104, and the mass spectrometer 105 all operate.

In some embodiments, the U-shaped ion mobility analyzer 102 selects the parent ions in the ion mobility selection window and transmits the selected parent ions to the downstream side, and the quadrupole mass filter 103 further selects the parent ions based on the mass-to-charge ratio thereof, and selects the parent ions in the mass selection window to transmit the selected parent ions to the lower level.

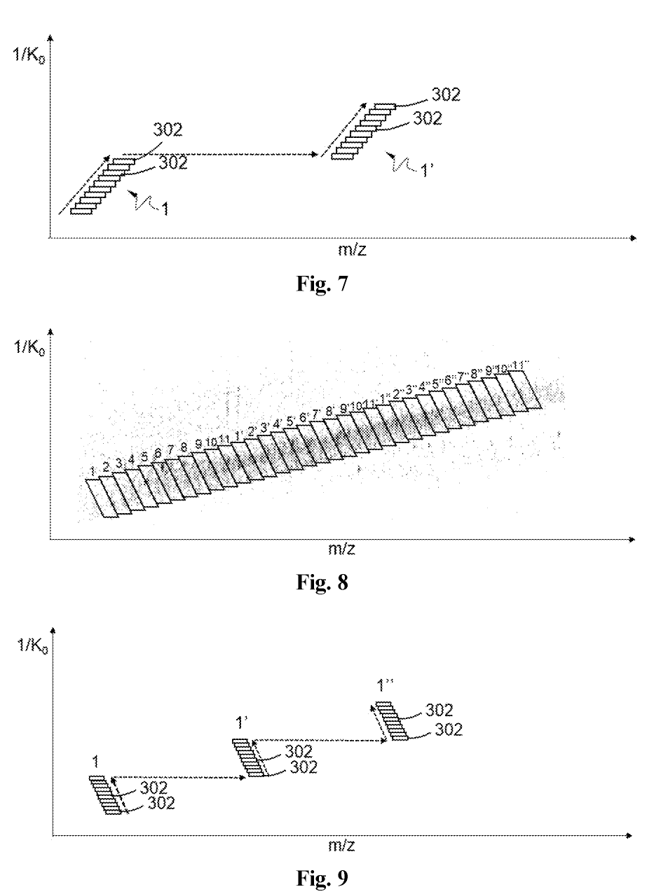

FIG. 7 shows how the U-shaped ion mobility analyzer 102 and the quadrupole mass filter 103 in the filtering mode complete the scan of the ion mobility-mass-to-charge ratio window in a parallelogram region. Referring to FIG. 7, the scan can be performed by further dividing the ion mobility-mass-to-charge ratio window of each parallelogram region into a plurality of rectangular steps, and continuously or stepwise varying the mass selection window.

Specifically, referring to FIGS. 6 and 7, one operation cycle of the tandem analysis step S4 includes 11 ion mobility spectrometry scan cycles, and each of the ion mobility spectrometry scan cycles further includes two temporally consecutive time periods, and each of the time periods corresponds to one ion mobility-mass-to-charge ratio window.

Referring to FIG. 7, during the time period corresponding to the ion mobility-mass-to-charge ratio window 1, and during the time period corresponding to the ion mobility-mass-to-charge ratio window 1', the U-shaped ion mobility analyzer 102 performs the scan stepwise, and the quadrupole mass filter 103 also performs the scan stepwise.

Taking the ion mobility-mass-to-charge ratio window 1 as an example, the ion mobility-mass-to-charge ratio window 1 is divided into a plurality of rectangular steps 302, and operations on the rectangular steps 302 are actually executed by the U-shaped ion mobility analyzer 102 and the quadrupole mass filter 103. Specifically, a width of each of the rectangular steps 302 along an X-axis direction is the mass selection window of the quadrupole mass filter 103, and a width of each of the rectangular steps 302 along a Y-axis direction corresponds to the ion mobility selection window of the U-shaped ion mobility analyzer 102.

During a process of executing the operation on the corresponding ion mobility-mass-to-charge ratio window 1, the U-shaped ion mobility analyzer 102 can operate in the filtering mode. Specifically, a direct current electric field E1 of the first channel CH1 is configured to be less than a direct current electric field E2 of the second channel CH2, and the direct current electric field E1 of the first channel CH1 and the direct current electric field E2 of the second channel CH2 are synchronously scanned while maintaining ΔE constant (ΔE = E2 - E1) to gradually scan the ion mobility selection windows of the respective rectangular steps 302 in a Y direction. In some embodiments, ΔE may be greater than 0, equal to 0, or less than 0. In an actual scan process, due to a continuous increase in a field strength, the ions experience different field strengths in the first channel CH1 and the second channel CH2, and thus ΔE is not necessarily set to a positive value. If ΔE = 0, or ΔE is set to a negative value close to 0, the ions still have a certain transmission rate. According to experiments, ΔE = 0 can achieve higher resolution while maintaining a high ion transmission efficiency, resulting in more accurate mobility and CCS values.

The synchronous scan by the U-shaped ion mobility analyzer 102 and the synchronous scan by the quadrupole mass filter 103 are at the same frequency. In other words, each time the ion mobility selection window in the Y-direction of the U-shaped ion mobility analyzer 102 is switched from the rectangular step 302 to another rectangular step 302, the mass selection window of the quadrupole mass filter 103 is also synchronously switched, correspondingly switching the rectangular step 302 to another rectangular step 302.

For example, in an initial stage of scanning the ion mobility-mass-to-charge ratio window 1, the ion mobility selection window of the U-shaped ion mobility analyzer 102 is configured to correspond to the ion mobility selection window in the Y-direction of the first rectangular step 302 in a lower left corner, and at the same time, the mass selection window of the quadrupole mass filter 103 is configured to correspond to a mass selection window in an X-direction of the first rectangular step 302 in the lower left corner. After a period of time, the ion mobility selection window of the U-shaped ion mobility analyzer 102 and the mass selection window of the quadrupole mass filter 103 are switched synchronously. The ion mobility selection window of the U-shaped ion mobility analyzer 102 is configured to correspond to the ion mobility selection window in the Y-direction of the second rectangular step 302 in the lower left corner, and at the same time, the mass selection window of the quadrupole mass filter 103 is configured to correspond to the mass selection window in the X-direction of the second rectangular step 302 in the lower left corner. In this way, the ion mobility selection window and the mass selection window are switched sequentially from the lower left corner to an upper right corner to scan the entire ion mobility-mass-to-charge ratio window 1.

After scanning the ion mobility-mass-to-charge ratio window 1, when switching windows from the ion mobility-mass-to-charge ratio window 1 to the ion mobility-mass-to-charge ratio window 1’, the preceding and succeeding ion mobility selection windows are essentially continuous, but the mass selection windows have a significant difference (for example, a difference greater than 2 Da, greater than 5 Da, or greater than 10 Da), and thus, the U-shaped ion mobility analyzer 102 can maintain the previously consistent switching step length and switching frequency, directly switch from the rectangular step 302 on an upper right corner of the ion mobility-mass-to-charge ratio window 1 to the rectangular step 302 on the lower left corner of the ion mobility-mass-to-charge ratio window 1', but the quadrupole mass filter 103 needs to perform a step change. In some embodiments of this application, the quadrupole mass filter 103 can be used as a mass filter to quickly and simply perform this step change.

The scan process of the ion mobility-mass-to-charge ratio window 1' is similar to the scan process of the ion mobility-mass-to-charge ratio window 1. After completing the scan on the ion mobility-mass-to-charge ratio window 1', a next ion mobility spectrometry scan cycle begins. The next ion mobility spectrometry scan cycle starts at the rectangular step 302 on a lower left corner of an ion mobility-mass-to-charge ratio window 2 and ends at the rectangular step 302 on an upper right corner of an ion mobility-mass-to-charge ratio window 2'. A scan process is similar to that in the first ion mobility spectrometry scan cycle, that is, the U-shaped ion mobility analyzer 102 performs continuous or stepwise scan during this ion mobility spectrometry scan cycle, but the quadrupole mass filter 103 needs to perform a step change on the mass selection window at a timing when the ion mobility-mass-to-charge ratio window 2 is switched to the ion mobility-mass-to-charge ratio window 2'.

Next, different ion mobility spectrometry scan cycles are performed sequentially until all 11 ion mobility spectrometry scan cycles are completed, that is, data acquisition for the ion mobility-mass-to-charge ratio two-dimensional heat map is completed once. The acquired mass spectral data is saved in association with the ion mobility spectral data ion mobility spectrometry data, thereby obtaining the data-independent acquisition data set.

According to the above method, the data independent acquisition method according to the one or more embodiments has the following advantages. First, the mass selection window of the parent ion is narrow, so that a data quality similar to that of DDA and better coverage of a region of interest can be achieved, and a higher scan speed can also be achieved. Second, the mass selection windows between the different rectangular steps 302 overlap each other, and thus, the assignment of the parent ion can be further inferred based on the overlapping relationship, and a computational efficiency and accuracy of deconvolution can be improved. Furthermore, in some embodiments, the slope k2 of the single ion mobility-mass-to-charge ratio window is smaller than the slope k1 of the trend line 301, and accordingly, a change in the mass selection windows of the adjacent rectangular steps 302 is smaller, so that assignment of the parent ion can be further inferred more accurately, and the data quality is improved. In addition, since the quadrupole mass filter 103 does not scan the entire mass number, but operates in a stepwise-scan and step change mode, that is, in every same ion mobility scan cycle, the quadrupole mass filter 103 has a narrower scan range, and correspondingly, a duration of each mass selection window is longer, allowing more ions to undergo subsequent analysis such as dissociation and fragmentation, and the data quality is further improved. In other words, if a dwell time for each of the mass windows is the same, a shorter ion mobility scan cycle can be used, facilitating a faster and higher-throughput analysis. In summary, compared to the related art, the data independent acquisition method according to the one or more embodiments can significantly improve the data quality (both in terms of narrowing a mass assignment window of the parent ions and improving ion utilization efficiency and allowing acquisition of more ions in the same window), increase the coverage, and provide a possibility of achieving a faster and higher-throughput analysis.

Some other embodiments of this application also provide a data independent acquisition method. The data independent acquisition method includes the pre-acquisition step S1, the heat map drawing step S2, the trend line determination step S3, and the tandem analysis step S4 as shown in FIG. 3. The content of each step is the same as that in FIG. 3, except that in the trend line determination step S3, the determined ion selection timing is different from that in FIG. 6, and accordingly, the scan method in the tandem analysis step S4 is also different from that in FIG. 7.

FIG. 8 shows the ion selection timing determined in the trend line determination step S3 of the data independent acquisition method according to other embodiments of this application. FIG. 9 is a schematic diagram of the specific scan method of the U-shaped ion mobility analyzer 102 and the quadrupole mass filter 103 operating in the filtering mode within one ion mobility spectrometry scan cycle in some embodiments of FIG. 8.

Referring to FIG. 8, in some embodiments, 33 ion mobility-mass-to-charge ratio windows are arranged in sequence along the trend line 301 with a negative slope k2. The 33 ion mobility-mass-to-charge ratio windows are divided into 11 groups, each group corresponds to a complete ion mobility spectrometry scan cycle, and in each ion mobility spectrometry scan cycle, the scan of the U-shaped ion mobility analyzer 102 is continuous or stepwise. The complete ion mobility spectrometry scan cycle includes three consecutive time periods, and each time period corresponds to scanning one ion mobility-mass-to-charge ratio window. For example, in the first ion mobility spectrometry scan cycle, the U-shaped ion mobility analyzer 102 performs the scan sequentially in the descending order of the ion mobility (ascending order of 1/K0), and the scan range covers ion mobility-mass-to-charge ratio windows 1, 1', and 1''. The quadrupole mass filter 103 needs to perform a step change on the mass selection range at the time of performing step changes from the ion mobility-mass-to-charge ratio window 1 to the ion mobility-mass-to-charge ratio window 1', and from the ion mobility-mass-to-charge ratio window 1' to the ion mobility-mass-to-charge ratio window 1''. In some embodiments, the slope of a negative value allows for a smaller vertical width of the ion mobility-mass-to-charge ratio window within each time period, that is, smaller changes in the ion mobility, thereby requiring more time periods to complete the scan of the entire mobility range. Since an ion duty cycle is directly related to the number of time periods, this method can achieve a higher ion duty cycle, that is, higher ion utilization efficiency.

In some embodiments, k1 * k2 = -1, that is, an inclination direction of the ion mobility-mass-to-charge ratio window can be perpendicular to an extension direction of the trend line 301. In these embodiments, a width of the ion mobility-mass-to-charge ratio window in a direction perpendicular to the extension direction of the trend line 301 can be more simply and accurately set based on a width of the region of interest, thereby ensuring the coverage of the region of interest. In other embodiments of this application, k2 can also be flexibly set based on other conditions. In some embodiments, a large absolute value of k2 can be set to reduce the magnitude of change in the mass selection window when switching the rectangular step 302, thereby facilitating the association of the parent ions and the daughter ions using repeatedly appeared information of the parent ions in different rectangular steps 302, and improving the accuracy of deconvolution calculation.

In addition, the one or more embodiments have described an example in which one ion mobility spectrometry scan cycle includes two or three time periods, and each time period corresponds to scanning one ion mobility-mass-to-charge ratio window. However, in other embodiments of this application, one ion mobility spectrometry scan cycle may also include four or more time periods, and the one or more embodiments of this application do not limit this respect.

Still referring to FIG. 9, in some embodiments, the U-shaped ion mobility analyzer 102 performs a continuous or stepwise unidirectional scan within one ion mobility spectrometry scan cycle, and the quadrupole mass filter 103 step changes twice to perform the scan, that is, one step change occurs at a timing of switching from the ion mobility-mass-to-charge ratio window 1 to the ion mobility-mass-to-charge ratio window 1', and the other step change occurs at a timing of switching from the ion mobility-mass-to-charge ratio window 1' to the ion mobility-mass-to-charge ratio window 1''. At the switching timing, since the ion mobility selection windows of the preceding and succeeding ion mobility-mass-to-charge ratio windows correspond to each other, the scan of the U-shaped ion mobility analyzer 102 remains stepwise and does not require a step change.

According to the above method, the data independent acquisition method according to one or more embodiments can improve a data quality, a scan speed, and coverage of the region of interest, or increase a duty cycle of an analysis, thereby improving a sensitivity and coverage of omics analysis.

The one or more embodiments are merely optional embodiments of this application and are not intended to limit this application. Any modifications, equivalent substitutions, and improvements made within the spirit and principles of this application should be included in the protection scope of this application.

What is claimed is:

1. A data independent acquisition method applied to an ion mobility spectrometer-tandem mass spectrometer, the ion mobility spectrometer-tandem mass spectrometer including an ion mobility analyzer, a mass filter, an ion dissociation device, and a mass spectrometer arranged in sequence, the data independent acquisition method comprising:
a pre-acquisition step of transporting, to the mass spectrometer, a parent ion that is analyzed by the ion mobility analyzer and is not dissociated by the ion dissociation device to obtain a parent ion pre-acquisition data set in which ion mobility spectral data of the parent ion is stored in association with mass spectral data of the parent ion; and
a tandem analysis step of controlling, using an ion selection timing determined based on the parent ion pre-acquisition data set, operations of the ion mobility analyzer and the mass filter to select the parent ion that satisfies the ion selection timing to enter the ion dissociation device, and transporting, to the mass spectrometer, a daughter ion obtained by dissociating the parent ion to obtain a data-independent acquisition data set, wherein
an operation cycle of the tandem analysis step includes a plurality of ion mobility spectrometry scan cycles, and the ion mobility analyzer performs a scan continuously or stepwise in each of the plurality of ion mobility spectrometry scan cycles, and
the ion mobility spectrometry scan cycle includes a plurality of time periods that are sequentially continuous with each other, and a mass selection window of the mass filter changes continuously or stepwise in each of the time periods and step changes at a timing of switching between the time periods.

2. The data independent acquisition method according to claim 1, wherein
the pre-acquisition step includes:
determining an ion mobility-mass-to-charge ratio two-dimensional heat map of the parent ion based on the parent ion pre-acquisition data set; and
the time period of the ion mobility spectrometry scan cycle is represented as a non-rectangular parallelogram region in the ion mobility-mass-to-charge ratio two-dimensional heat map according to the mass selection window and an ion mobility selection window.

3. The data independent acquisition method according to claim 2, further comprising:
a trend line determination step of determining one or more trend lines based on a contour of a region with a relatively high heat value in the ion mobility-mass-to-charge ratio two-dimensional heat map.

4. The data independent acquisition method according to claim 3, wherein
in each of the time periods, a slope of the parallelogram region is different from a slope of the one or more trend lines.

5. The data independent acquisition method according to claim 4, wherein
in the ion mobility-mass-to-charge ratio two-dimensional heat map, 1/K0 is set as a vertical axis, a mass-to-charge ratio m/z is set as a horizontal axis, K0 represents a reduced ion mobility, and the slope of the parallelogram region is greater than the slope of the one or more trend lines.

6. The data independent acquisition method according to claim 2, wherein
in the ion mobility spectrometry scan cycle, an ion mobility selected by the ion mobility analyzer increases or decreases in sequence over time.

7. The data independent acquisition method according to claim 1, wherein
in the ion mobility spectrometry scan cycles, widths of ion mobility ranges scanned by the ion mobility analyzer are equal.

8. The data independent acquisition method according to claim 7, wherein
in n time periods of one of the ion mobility spectrometry scan cycles, window widths of respective ion mobility selection windows scanned by the ion mobility analyzer are equal.

9. The data independent acquisition method according to claim 1, wherein
a width of the mass selection window of the mass filter remains unchanged.

10. The data independent acquisition method according to claim 1, wherein
the ion mobility analyzer includes an ion inlet, an ion outlet, and an ion channel which includes a first channel and a second channel arranged in parallel, and in an ion path from the ion inlet to the ion outlet, a moving direction of the parent ion in the first channel is opposite to a moving direction of the parent ion in the second channel.

11. The data independent acquisition method according to claim 10, wherein
the parent ion is stored, selected, or excluded in the ion channel according to a comparison of magnitudes of a gas flow force and an electric field force applied to the parent ion along a length direction of the ion channel.

12. The data independent acquisition method according to claim 11, wherein
the tandem analysis step further includes:
storing the parent ion outside the ion mobility selection window in the first channel, or storing the parent ion outside the ion mobility selection window at an end of the second channel away from the ion outlet; and
releasing the parent ion to a lower level through the second channel and the ion outlet in an order of ion mobilities.

13. The data independent acquisition method according to claim 11, wherein
the excluded parent ion leaves the ion mobility analyzer through an opening at an end of the ion channel different from the ion outlet.

14. The data independent acquisition method according to claim 1, wherein
in n time periods of one of the ion mobility spectrometry scan cycles, step lengths of step changes of the mass selection window between different time periods are equal.

15. An ion mobility spectrometer-tandem mass spectrometer to which the data independent acquisition method according to claim 1 is applied.

16. The ion mobility spectrometer-tandem mass spectrometer according to claim 15, wherein
the mass filter is a quadrupole mass filter, the ion mobility analyzer is a U-shaped ion mobility analyzer or a trapped ion mobility analyzer, and the mass spectrometer is a time-of-flight mass spectrometer.
